(19) United States
(12) Patent Application Publication
(10) Pub. No.: US 2006/0245122 A1
(43) Pub. Date: Nov. 2, 2006

(54) Electrical load switch

(76) Inventor: Manfred Drawe, Norfolk, MA (US)

Correspondence Address: GREENBERG TRAURIG, LLP, ONE INTERNATIONAL PLACE, 20th FL, ATTN: PATENT ADMINISTRATOR, BOSTON, MA, 02110, US

(21) Appl. No.: 11/116,732

(22) Filed: Apr. 28, 2005

(51) Int. Cl. H02H 7/00

(52) U.S. Cl. 361/18

(57) ABSTRACT

An electrical load switch for being electrically connected across a load and for selectively bypassing the load includes two MOSFETs having their sources connected together and their two drains respectively connected to two terminals of the load, a photovoltaic MOSFET driver connected to the gates of the two MOSFETs for supplying a voltage on the two gates, and a photoMOS relay connected between the gates and the sources of the two MOSFETs to switch the two MOSFETs between on and off states. When the two MOSFETs are turned off, the electrical load switch forms an open circuit, and when the two MOSFETs are turned on, the electrical load switch forms a short circuit bypassing the load.

### FIELD OF THE INVENTION

The present invention relates generally to electrical load switches, and more particularly, relates to floating load switches.

### BACKGROUND OF THE INVENTION

Conventional load switching devices or power relays typically include mechanical switch contacts that are used to switch an electrical circuit. One disadvantage of the conventional load switching device is that the device takes up a relatively large area on an application board where the device is mounted. The life expectancy of the mechanical structure in the load switching device is relatively short, and thereby the overall system reliability of the load switching device is significantly limited. Also, the performance of these conventional load switching devices is not desirable in a circuit that requires fast response because the time delay of the mechanical structure is relatively long.

Therefore, there is a need for an electrical load switch that is space-saving on an application board and is less expensive than the conventional load switches, and also has improved life expectancy and performance compared to prior art devices.

### SUMMARY OF THE INVENTION

The present invention provides an electrical floating load switch for being electrically connected across a load on the output of a device under test and selectively bypassing the load. According to one aspect of the present invention, the electrical floating load switch includes two MOSFETs each having a gate, a drain, and a source. The sources of the two MOSFETs are tied together and the drains of the two MOSFETs are respectively connected to terminals of the load to be bypassed. A power supply, preferably adapted to provide a constant turn-on voltage to the MOSFETs, is connected to the gates of the two MOSFETs. In one preferred form, the power supply is a photovoltaic MOSFET driver. The electrical floating load switch further includes a switching device connected between the gates and the sources of the MOSFETs for selectively connecting the gates to the sources to turn off the MOSFETs or disconnecting the gates from the sources to turn on the MOSFETs. In one preferred form, the switching device is a photoMOS relay having one terminal connected to the gates of the MOSFETs and the other terminal connected to the sources of the MOSFETs. In one preferred embodiment, the power supply and the switching device are connected to the gate of one of the MOSFETs directly and are connected to the gate of the other MOSFET through a resistor. The resistor preferably has a resistance of about 100 ohms, although other values may be used.

The switching device preferably is controlled externally by an automated test equipment (ATE) or by other preprogrammed controllers. In operation, when the switching device is closed, the switching device provides a short circuit between the gates and the sources of the two MOSFETs and brings the voltage of the gates down to the same voltage as the source or close to the voltage of the source. In this state (with the switching device closed), the MOSFETs are turned off, and there is substantially no current passing through the MOSFETs, and the current from the power supply passes through the load. When the switching device is opened, the switching device forms an open circuit and there is no connection between the gates and the sources of the MOSFETs. The voltage generated by the power supply and applied to the gates of the MOSFETs turns on the two MOSFETs, and the two MOSFETs form a short circuit bypassing the load. The resistor between the two gates delays the turn-on time of one of the two MOSFETs to prevent oscillation of the two MOSFETs.

According to another aspect of the present invention, the electrical floating load switch floats above ground and is independent of the voltages that are on the load of the device under test. According to a further aspect of the present invention, the electrical floating load switch does not have any mechanical parts, thereby to avoid problems generally caused by the mechanical parts, such as delay and reliability problems. The electrical floating load switch without any mechanical parts according to the present invention also saves space on the application board.

### BRIEF DESCRIPTION OF THE DRAWINGS

FIG. 1 is a schematic diagram of an electrical load switch according to one preferred embodiment of the present invention.

### DETAILED DESCRIPTION OF THE PREFERRED EMBODIMENTS

The present invention provides an electrical floating load switch. According to one aspect of the present invention, the floating load switch is designed to function similarly to a coil relay, but does not have any mechanical parts, thereby to avoid problems generally caused by the mechanical parts, such as delay and reliability problems, as in the prior art relays.

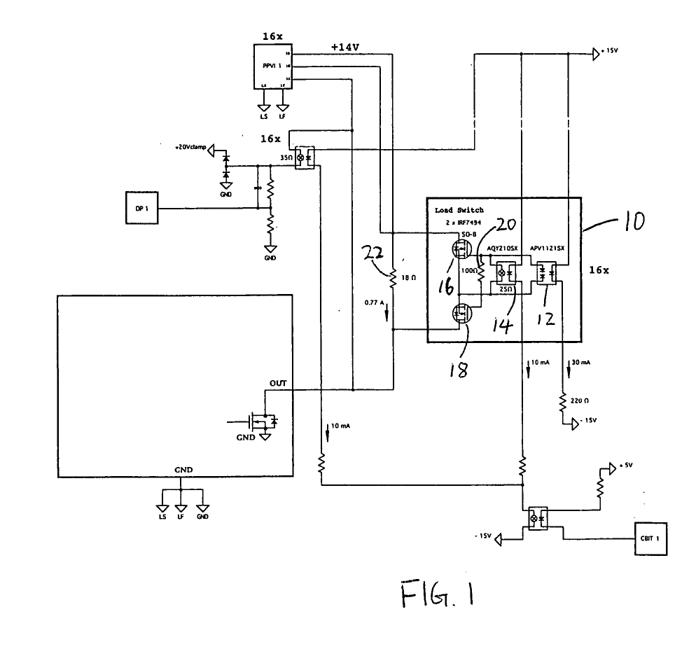

FIG. 1 illustrates an electrical floating load switch 10 on an application board constructed in accordance with the present invention. As shown in FIG. 1, according to one preferred embodiment of the present invention, the floating load switch 10 includes a photovoltaic MOSFET driver 12 (for example, photovoltaic MOSFET driver with a product model number APV1121S), a switching device 14, preferably a photoMOS relay (for example, photoMOS relay with a product model number AQ210S), and two power MOSFETs 16, 18 (for example, power MOSFET with a product model number IRF7494), and a resistor 20 preferably but not necessarily with about 100 ohms resistance. The two power MOSFETs 16 and 18 have their sources connected together and drains connected to two terminals of a load 22 of a device under test (DUT). One terminal of the photoMOS relay 14 is connected to the gate of one of the power MOSFETs, for example, the power MOSFET 16, and also connected to the gate of the other power MOSFET 18 through the resistor 20. Another terminal of the photoMOS relay 14 is connected to the sources of the power MOSFETs 16 and 18. The photovoltaic MOSFET driver 12 is connected to the two power MOSFETs 16 and 18 in the same way as the photoMOS relay 14, with one terminal connected to the gates and one terminal connected to the sources.

In operation, the photovoltaic MOSFET driver 12 sets up 6 to 8 volts voltage to be applied to the gates of the two power MOSFETs 16 and 18. The photoMOS relay 14 is used to switch both MOSFETs 16 and 18 between on and off states. The photoMOS relay 14, which is connected between the gates and the sources of the MOSFETs 16 and 18, when turned on, connects the gates of the MOSFETs 16 and 18 to the sources. This short circuit provided by the photoMOS relay 14 between the gates and the sources shuts off the MOSFETs 16 and 18 preventing them from conducting current. By putting the power MOSFETs 16 and 18 back to back with their sources tied together, when the MOSFETs 16 and 18 are turned off, there is substantially no current passing through the body diodes of the MOSFETs 16 and 18. When the photoMOS relay 14 is turned off, there is no connection between the gates and sources of the MOSFETs 16 and 18 through the photoMOS relay 14. The voltages applied by the photovoltaic MOSFET driver 12 to the gates of the MOSFETs 16 and 18 turn on the MOSFETs 16 and 18, and current can flow through the MOSFETs 16 and 18, and thereby, the load 22 of the device under test is bypassed by the MOSFETs 16 and 18.

One of the power MOSFETs 16 and 18 has its gate connected to the switching device (photoMOS relay 14) and/or the power supply (the photovoltaic MOSFET driver 12) through the resistor 20. The resistor 20 delays the turn-on time of that transistor, thereby preventing oscillation of the two MOSFETs 16 and 18. If both MOSFETs 16 and 18 are turned on at the same time, one of the MOSFETs will be momentarily shut off or oscillate due to the change in voltage caused by the other MOSFET. In the exemplary embodiment shown in FIG. 1, the gate of the MOSFET 18 is connected to the power supply 12 and the switching device 14 through the resistor 20. Alternatively, the gate of the MOSFET 16 can be connected to the power supply 12 and the switching device 14 through a resistor and the gate of the MOSFET 18 is directly connected to the power supply 12 and the switching device 14.

The photoMOS relay 14 can be controlled externally by an automated test equipment (ATE) or other preprogrammed controllers. As described above, the floating load switch 10 is turned on by turning off the photoMOS relay 14, and the load 22 of the device under test is bypassed by the floating load switch 10; the floating load switch 10 is turned off by turning on the photoMOS relay 14, and the current flows through the load 22.

The electrical floating load switch floats above ground and is independent of the voltages that are on the load of the device under test. The size of the components of the floating load switch 10 constructed according to the present invention is minimized, and, the life expectancy, the switching time, and the reliability of the floating load switch 10 are improved. The area that the floating load switch requires on an application board is about ⅔ less than the conventional load switches. Since the floating load switch 10 has no mechanical parts, its life expectancy is much greater than the conventional power load switches, thus improving the overall system reliability. The floating load switch 10 can handle a 150V, 40 A pulsed current. The on/off switching time of the floating load switch 10 is about 500 μs, where a mechanical power relay of equivalent power ratings has a switching time in the range of 2-10 ms.

While the claimed invention has been described in detail and with reference to specific embodiments thereof, it will be apparent to one of ordinary skill in the art that various changes and modifications can be made to the claimed invention without departing from the spirit and scope thereof. Thus, for example those skilled in the art will recognize, or be able to ascertain, using no more than routine experimentation, numerous equivalents to the specific substances and procedures described herein. Such equivalents are considered to be within the scope of this invention, and are covered by the following claims.

What is claimed is:

1. An electrical load switch for selectively bypassing two terminals of a load, comprising:
a first and second MOSFETs each having a gate, a drain, and a source, said two MOSFETs having their sources connected together, and having their two drains adapted for coupling to respective terminals of said load;
a power supply connected to the gates of the two MOSFETs for supplying a voltage sufficient to turn on said MOSFETs; and
a switching device connected between the gates and the sources of the two MOSFETs, wherein said switch is adapted to selectively connect the gates to the sources to turn off the MOSFETs or disconnect the gates from the sources to turn on the MOSFETs.

2. An electrical load switch according to claim 1 further comprising a resistor connected between the gate of one of said two MOSFETs and the source of the other of said two MOSFETs.

3. An electrical load switch according to claim 2, wherein said resistor is about 100 ohms.

4. An electrical load switch according to claim 2, wherein said switching device is connected to the gate of one of said MOSFETs directly and connected to the gate of the other MOSFET through said resistor.

5. An electrical load switch according to claim 1, wherein said power supply comprises a photovoltaic MOSFET driver.

6. An electrical load switch according to claim 1, wherein said switching device comprises a photoMOS relay.

7. An electrical load switch for selectively bypassing a load, comprising:
a first and second MOSFETs each having a gate, a drain, and a source, wherein said two MOSFETs having their sources connected together, and having their two drains respectively adapted for coupling to two terminals of said load;
a photovoltaic MOSFET driver connected to the gates of the two MOSFETs for supplying a voltage sufficient to turn on said MOSFETs on said two gates; and
a photoMOS relay connected between the gates and the sources of the two MOSFETs, wherein said photoMOS relay is adapted to selectively connect the gates to the sources to turn off the MOSFETs or to disconnect the gates from the sources to turn on the MOSFETs.

8. An electrical load switch according to claim 7 further comprising a resistor connected between two gates of said two MOSFETs.

9. An electrical load switch according to claim 8, wherein said resistor is about 100 ohms.

10. An electrical load switch according to claim 8, wherein said photoMOS relay is connected to the gate of one of said MOSFETs directly and connected to the gate of the other MOSFET through said resistor.
